(19) United States
(12) Patent Application Publication
(10) Pub. No.: US 2025/0008361 A1
(43) Pub. Date: Jan. 2, 2025

(54) METHOD AND APPARATUS FOR SUPPORTING MEASUREMENT GAP ENHANCEMENTS IN DUAL CONNECTIVITY

(71) Applicant: SAMSUNG ELECTRONICS CO., LTD., Suwon-si, Gyeonggi-do (KR)

(72) Inventors: Aby Kanneath ABRAHAM, Muvattupuzha (IN); Vinay Kumar SHRIVASTAVA, Bengaluru (IN)

(21) Appl. No.: 18/692,280

(22) PCT Filed: Sep. 8, 2022
(86) PCT No.: PCT/KR2022/013572

§ 371 Date: Mar. 14, 2024

(30) Foreign Application Priority Data
Sep. 14, 2021 (IN) 202141041344
Aug. 14, 2022 (IN) 202141041344

(51) Int. Cl. H04W 24/10; H04W 76/15

(52) U.S. Cl. CPC H04W 24/10; H04W 76/15

(57) ABSTRACT

The disclosure relates to a 5G or 6G communication system for supporting a higher data transmission rate. Embodiments herein provide a method for handling measurement gap during dual connectivity operation in a wireless network (1000). The method includes receiving, by a second node (200) in the wireless network (1000), an Inter-Node Message (INM) comprising a configuration from a first node (100) in the wireless network (1000) to configure measurement gap for at least one UE (300) associated with the second node (200) with measurement gap.

### TECHNICAL FIELD

The present disclosure relates to a wireless communication system, and more specifically related to methods and a wireless network for configuration and operation of measurement gap enhancements which includes configuring multiple measurement gaps, preconfigured gaps and network controlled small gaps (NCSG) during dual connectivity operations.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHz” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

The principal object of the embodiments herein is to provide a method and a wireless network for supporting measurement gap enhancements in a dual connectivity, so as to enable the optimal measurement gap configuration leading to increased NR performance for DC in the wireless network.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 illustrates a wireless network for handling measurement gap during dual connectivity operation, according to the embodiments as disclosed herein;

FIG. 2 shows various hardware components of the first node, according to the embodiments as disclosed herein;

FIG. 3 shows various hardware components of a second node, according to the embodiments as disclosed herein;

FIG. 4 is a flow chart illustrating a method, implemented by the first node, for handling the measurement gap during the dual connectivity operation in the wireless network, according to the embodiments as disclosed herein;

FIG. 5 is a flow chart illustrating a method, implemented by the second node, for handling the measurement gap during the dual connectivity operation in the wireless network, according to the embodiments as disclosed herein;

FIG. 6 is another flow chart illustrating a method, implemented by the second node, for handling the measurement gap during the dual connectivity operation in the wireless network, according to the embodiments as disclosed herein;

FIG. 7 is another flow chart illustrating a method, implemented by the first node, for handling the measurement gap during the dual connectivity operation in the wireless network, according to the embodiments as disclosed herein;

FIG. 8 is a flow chart illustrating a MGE reconfiguration at a DC setup, according to the embodiments as disclosed herein;

FIG. 9 is a flow chart illustrating a MGE reconfiguration at the DC setup, according to the embodiments as disclosed herein;

FIG. 10 illustrates an example scenario of updating the MN on SN capability for NR measurement enhancement, according to the embodiments as disclosed herein;

FIG. 11 illustrates an example inter node capability coordination for per FR2 gaps in EN-DC/NG-EN-DC where the MN doesn't support NR measurement enhancement algorithm block, according to the embodiments as disclosed herein;

FIG. 12 illustrates an example scenario of MN-SN coordination during configuration of multiple gaps and preconfigured gaps, according to the embodiments as disclosed herein;

FIG. 13 illustrates an example scenario of gap activation due to BWP switch/SCell addition or activation/SCG activation at the SN, according to the embodiments as disclosed herein;

FIG. 14 illustrates an example scenario of gap deactivation due to BWP switch/SCell release or deactivation/SCG deactivation at the SN, according to the embodiments as disclosed herein;

FIG. 15 illustrates an example scenario of gap activation due to BWP switch/SCell addition or activation/SCG activation at the MN, according to the embodiments as disclosed herein;

FIG. 16 illustrates an example scenario of gap deactivation due to BWP switch/SCell release or deactivation/SCG deactivation at the MN, according to the embodiments as disclosed herein; and

FIG. 17 illustrates a scenario of MN-SN coordination on max number of gaps to be configured, according to the embodiments as disclosed herein.

### BEST MODE FOR CARRYING OUT THE INVENTION

Accordingly, the embodiment herein is to provide a method for handling measurement gap during a dual connectivity operation in a wireless network. The method includes detecting, by a first node in the wireless network, whether the first node has capability to support one of a preconfigured measurement gap, multiple measurement gaps, a network controlled small gap (NCSG), a maximum number of multiple measurement gaps and a maximum number of NCSG. Further, the method includes generating, by a first node, a configuration (e.g., Cell Group (CG) configuration or the like) comprising a first node capability when the first node has capability to support one of the preconfigured measurement gap, the multiple measurement gaps, and the NCSG. Further, the method includes sending, by the first node, an Inter-Node Message (INM) comprising the configuration including the first node capability to a second node in the wireless network to configure measurement gap for at least one User Equipment (UE) associated with the second node. Further, the method includes receiving, by the first node, an Inter-Node Message (INM) comprising a configuration information (e.g., CG configuration information or the like) from the second node, wherein the configuration information comprises information of the measurement gap created for the at least one UE.

In an embodiment, further, the method includes generating, by the first node, a CG configuration comprising a list of frequencies to be configured for measurements by the first node and multiple measurement gaps to be created by the second node for those frequencies, whether preconfigured measurement gap is preferred or required for those measurement gaps and status of the activation status of the preconfigured measurement gap. Further, the method includes sending, by the first node, an INM comprising the CG Config configuration to the second node in the wireless network for configuration of the multiple measurement gaps for the at least one UE. Further, the method includes receiving, by the first node, an INM comprising a CG configuration information from the second node, wherein the CG configuration information comprises the multiple measurement gaps created by the second node for the at least one UE, a mapping of the multiple measurement gaps to at least one frequency of the list of frequencies supported by the first node, type of multiple measurement gaps for identifying the multiple measurement gaps as preconfigured or not and the activation status of the preconfigured multiple measurement gaps.

In an embodiment, further, the method includes detecting, by the first node, at least one of a bandwidth part (BWP) switch, a secondary cell addition, a secondary cell activation, and a secondary cell group (SCG) activation. Further, the method includes generating, by the first node, a INM comprising one of CG Config or CGConfigInfo comprising a status indicating activation of at least one preconfigured measurement gap from the multiple measurement gaps based on the at least one of the BWP switch, the secondary cell addition, the secondary cell activation, and the SCG activation. Further, the method includes sending, by the first node, an INM comprising a CG Config to the second node for activation of the at least one preconfigured measurement gap for the at least one UE. Further, the method includes receiving, by the first node, an INM comprising a CG configuration information from the second node, wherein the CG configuration information indicates activation of the at least one measurement gap for the at least one UE by the second node. Further, the method includes activating, by the first node, the at least one measurement gap for the at least one UE in response to receiving the CG configuration information from the second node.

In an embodiment, the method includes detecting, by the first node, at least one of the BWP switch, the secondary cell release, the secondary cell deactivation, and the SCG deactivation. Further, the method includes generating, by the first node, an INM comprising a CG Config comprising a status indicating deactivation of the at least one measurement gap based on the at least one of the BWP switch, the secondary cell release, the secondary cell deactivation, and the SCG deactivation. Further, the method includes sending, by the first node, an INM comprising a CG Config to the second node indicating deactivation of the at least one measurement gap for the at least one UE. Further, the method includes receiving, by the first node, an INM comprising a CG configuration information from the second node, wherein the CG configuration information indicates deactivation of the at least one measurement gap for the at least one UE by the second node. Further, the method includes deactivating, by the first node, the at least one measurement gap for the at least one UE in response to receiving the CG configuration information from the second node.

In an embodiment, further, the method includes receiving, by the first node, an INM comprising a CG configuration information about activation of the at least one measurement gap for the at least one UE by the second node when the second node detects at least one of a BWP switch, a secondary cell addition, a secondary cell activation, and a SCG activation. Further, the method includes activating, by the first node, the at least one measurement gap for the at least one UE in response to receiving the CG configuration information from the second node.

In an embodiment, further, the method includes receiving, by the first node, an INM comprising a CG configuration information about deactivation of the at least one measurement gap for the at least one UE by the second node when the second node detects at least one of the BWP switch, the secondary cell release, the secondary cell deactivation, and the SCG deactivation. Further, the method includes deactivating, by the first node, the at least one measurement gap for the at least one UE in response to receiving the CG configuration information from the second node.

In an embodiment, the first node is a secondary node (SN), and the second node is a master node (MN). The configuration comprises Cell Group (CG) configuration, configuration Information comprises Cell Group (CG) configuration Information, wherein the INM send by the first node is a CG configuration, and the INM send by the second node is a CG configuration information.

Accordingly, the embodiment herein is to provide a method for handling measurement gap during dual connectivity operation in a wireless network. The method includes receiving, by a second node in the wireless network, an Inter-Node Message (INM) comprising a configuration (e.g., CG configuration or the like) from a first node in the wireless network to configure measurement gap for at least one UE associated with the second node with measurement gap. Further, the method includes creating, by the second node, the at least one UE with the measurement gap for the at least one UE based on the configuration. Further, the method includes sending, by the second node, an INM comprising a configuration information (e.g., CG configuration information or the like) to the first node, wherein the configuration information comprises information of the measurement gap created for the at least one UE.

In an embodiment, creating the at least one UE with the measurement gap based on the first node capability includes determining, by the second node, whether the CG configuration includes the first node capability to support at least one of a preconfigured measurement gap, multiple measurement gaps, the NCSG, the maximum number of multiple measurement gaps and the maximum number of NCSG; and performing, by the second node, one of: creating the at least one UE with at least one of the preconfigured measurement gap, the multiple measurement gaps based on the maximum number of multiple measurement gaps, and the NCSG based on the maximum number of NCSG when the CG configuration includes first node capability to support at least one of the preconfigured measurement gap, the multiple measurement gaps, and the NCSG, and creating the at least one UE with a single measurement gap when the CG configuration does not includes the first node capability.

In an embodiment, further, the method includes determining, by the second node, whether the measurement gaps are per UE gaps or per FR gap and at least one serving cell in the first node has a frequency in same FR in the first node. Further, the method includes creating, by the second node, the at least one UE with at least one of the preconfigured measurement gap, the multiple measurement gaps, and the NCSG based on the measurement gaps are per UE gaps or per FR gap and at least one serving cell in the first node has a frequency in same FR in the first node.

In an embodiment, the method includes creating, by the second node, the at least one UE with at least one of the preconfigured measurement gap, the multiple measurement gaps based on the maximum number of multiple measurement gaps, and the NCSG when no dual connectivity is established. Further, the method includes determining, by the second node, addition of the first node and establishment of the dual connectivity. Further, the method includes determining, by the second node, whether the CG configuration includes the first node capability to support at least one of a preconfigured measurement gap, multiple measurement gaps, the NCSG, the maximum number of multiple measurement gaps and the maximum number of NCSG. Further, the method includes reconfiguring the at least one UE with a single measurement gap when at least one of the dual connectivity is established and the CG configuration does not include first node capability to support at least one of the preconfigured measurement gap, the multiple measurement gaps, and the NCSG.

In an embodiment, the method includes receiving, the second node, an INM comprising a CG configuration from the first node for configuration of the multiple measurement gaps for the at least one UE associated with the second node, wherein the CG configuration comprises a list of frequencies supported by the first node and multiple measurement gaps to be created by the second node, and a status of the multiple measurement gaps to be activated by the second node. Further, the method includes creating, by the second node, the multiple measurement gaps for the at least one UE by mapping the multiple measurement gaps to the list of frequencies supported by the first node and marking the status of the multiple measurement gaps as active by the second node. Further, the method includes sending, by the second node, an InterNode Message (INM) comprising a CG configuration information to the first node, wherein the CG configuration information comprises information of the multiple measurement gaps created by the second node for the at least one UE, a mapping of the multiple measurement gaps to at least one frequency of the list of frequencies supported by the first node, type of multiple measurement gaps for identifying the multiple measurement gaps as preconfigured or not and the activation status of the created multiple preconfigured measurement gaps.

In an embodiment, further, the method includes detecting, by the second node, at least one of a bandwidth part (BWP) switch, a secondary cell addition, a secondary cell activation, and a secondary cell group (SCG) activation. Further, the method includes activating, by the second node, the at least one measurement gap based on at least one of the BWP switch, the secondary cell addition, the secondary cell activation, and the SCG activation. Further, the method includes sending, by the second node, an INM comprising a CG configuration information to the first node, wherein the CG configuration information indicates activation of the at least one measurement gap for the at least one UE by the second node.

In an embodiment, further, the method includes detecting, by the second node, at least one of the BWP switch, the secondary cell release, the secondary cell deactivation, and the SCG deactivation. Further, the method includes deactivating, by the second node, the at least one measurement gap based on at least one of the BWP switch, the secondary cell release, the secondary cell deactivation, and the SCG deactivation. Further, the method includes sending, by the second node, an INM comprising a CG configuration information to the first node, wherein the CG configuration information indicates deactivation of the at least one measurement gap for the at least one UE by the second node.

In an embodiment, further, the method includes receiving, by the second node from the first node, an INM comprising a CG configuration information about activation of the at least one measurement gap for the at least one UE by the second node when the first node detects at least one of a BWP switch, a secondary cell addition, a secondary cell activation, and a SCG activation. Further, the method includes activating, by the second node, the at least one measurement gap for the at least one UE in response to receiving the CG configuration information from the first node. Further, the method includes sending, by the second node, an INM comprising a CG configuration information to the first node, wherein the CG configuration information indicates deactivation of the at least one measurement gap for the at least one UE by the second node.

In an embodiment, further, the method includes receiving, by the second node from the first node, an INM comprising a CG configuration information about deactivation of the at least one measurement gap for the at least one UE by the second node when the first node detects the at least one of the BWP switch, the secondary cell release, the secondary cell deactivation, and the SCG deactivation. Further, the method includes deactivating, by the second node, the at least one measurement gap for the at least one UE in response to receiving the CG configuration information from the first node. Further, the method includes sending, by the second node, an INM comprising a CG configuration information to the first node, wherein the CG configuration information indicates deactivation of the at least one measurement gap for the at least one UE by the second node.

Accordingly, the embodiment herein is to provide a first node for handling measurement gap during dual connectivity operation in a wireless network. The first node includes a DC measurement gap controller communicatively coupled to a memory and a processor. The DC measurement gap controller is configured to detect whether the first node has capability to support one of a preconfigured measurement gap, multiple measurement gaps, a network controlled small gap (NCSG), a maximum number of multiple measurement gaps and a maximum number of NCSG. Further, the DC measurement gap controller is configured to generate a CellGroup (CG) configuration comprising a first node capability when first node has capability to support one of the preconfigured measurement gap, the multiple measurement gaps, and the NCSG. Further, the DC measurement gap controller is configured to send an INM comprising the CG configuration including the first node capability to a second node in the wireless network to configure measurement gap for at least one UE associated with the second node. Further, the DC measurement gap controller is configured to receive an Inter-Node Message (INM) comprising a CG configuration information from the second node, wherein the CG configuration information comprises information of the measurement gap created for the at least one UE.

Accordingly, the embodiment herein is to provide a second node for handling measurement gap during dual connectivity operation in a wireless network. The second node includes a DC measurement gap controller communicatively coupled to a memory and a processor. The DC measurement gap controller is configured to receive an INM comprising a CG configuration from a first node in the wireless network to configure measurement gap for at least one User Equipment (UE) associated with the second node with measurement gap. Further, the DC measurement gap controller is configured to create the at least one UE with the measurement gap for the at least one UE based on the CG configuration. Further, the DC measurement gap controller is configured to send an Inter-Node Message (INM) comprising a CG configuration information to the first node, wherein the CG configuration information comprises information of the measurement gap created for the at least one UE.

Accordingly, the embodiment herein is to provide a method for handling measurement gap during a dual connectivity operation in a wireless network. The method includes detects if the second node has any serving cell on a Frequency Range 2 (FR2) of the wireless network. Further, the method includes generating, by the second node, a CG configuration Information comprising at least one of allowed preconfigured measurement gap, a maximum number of measurement gaps allowed to be created by the first node, and a maximum number of network controlled small gap (NCSG) allowed to be created by the first node when the second node has no serving cell on the FR2 of the wireless network. Further, the method includes sending, by the second node, an Inter-Node Message (INM) comprising the CG configuration Information to a first node in the wireless network for configuring at least one UE associated with the first node with measurement gap. Further, the method includes detecting, by the second node, that second node has at least one serving cell is on the FR2 of the wireless network. Further, the method includes generating, by the second node, a Cell Group (CG) configuration comprising at least one of not allowed preconfigured measurement gap allowed, a maximum number of measurement gaps created by the second node as zero, and a maximum number of network controlled small gap (NCSG) as zero. Further, the method includes sending, by the second node, an INM comprising the CG configuration to the first node for configuring the at least one UE associated with the first node with measurement gap.

In an embodiment, further, the method includes generating, by the second node, a CG configuration comprising number of measurement gaps on the FR2 allowed and the number of NCSG on the FR2 allowed. Further, the method includes sending, by the second node, an INM comprising the CG Config configuration to the first node for configuration of the multiple measurement gaps for the at least one UE. Further, the method includes receiving, by the second node, an INM comprising a CG configuration information from the first node, wherein the CG configuration information comprises the multiple measurement gaps created on the FR2 by the first node for the at least one UE, and the multiple NCSG created on the FR2 by the first node.

Accordingly, the embodiment herein is to provide a method for handling measurement gap during dual connectivity operation in a wireless network. The method includes receiving, by the first node in the wireless network, an Inter-Node Message (INM) comprising a CG configuration Information from a second node in the wireless network, wherein the CG configuration comprises at least one of allowed preconfigured measurement gap, a maximum number of measurement gaps created by the second node, and a maximum number of network controlled small gap (NCSG). Further, the method includes configuring, by the first node, at least one UE associated with the first node with at least one of the allowed preconfigured measurement gap on the FR2 of the wireless network, the multiple measurement gaps on the FR2 of the wireless network, and NCSG on the FR2 of the wireless network. Further, the method includes receiving, by the first node, an INM comprising a CG configuration from the second node when at least one serving cell is added on the FR2 of the wireless network, wherein the CG configuration comprises at least one of not allowed preconfigured measurement gap, a maximum number of measurement gaps created by the second node as zero, and a maximum number of NCSG as zero. Further, the method includes releasing, by the first node, at least one of the not allowed preconfigured measurement gap created on the FR2 of the wireless network, the multiple measurement gaps created on the FR2 of the wireless network, and the multiple NCSG created on the FR2 of the wireless network. Further, the method includes creating, by the first node, the at least one UE associated with the first node with a single measurement gap on the FR2 of the wireless network.

In an embodiment, further, the method includes receiving, by the first node, an INM comprising a CG Config configuration from the second node for configuration of the multiple measurement gaps for the at least one UE, wherein the CG configuration comprises measurement gap on the FR2 is allowed and the NCSG on the FR2 is allowed. Further, the method includes creating, by the first node, the measurement gap on the FR2 and the NCSG on the FR2 within the limits as configured by the second node. Further, the method includes sending, by the first node, an INM comprising a CG configuration information to the second node, wherein the CG configuration information comprises the multiple measurement gaps created on the FR2 by the first node for the at least one UE, and the NCSG created on the FR2 by the first node.

Accordingly, the embodiment herein is to provide a second node for handling measurement gap during dual connectivity operation in a wireless network. The second node includes a DC measurement gap controller communicatively coupled to a memory and a processor. The DC measurement gap controller is configured to detect if the second node has any serving cell on a Frequency Range 2 (FR2) of the wireless network. Further, the DC measurement gap controller is configured to generate the CG configuration Information comprising at least one of allowed preconfigured measurement gap, a maximum number of measurement gaps allowed to be created by the first node, and a maximum number of network controlled small gap (NCSG) allowed to be created by the first node when the second node has no serving cell on the FR2 of the wireless network. Further, the DC measurement gap controller is configured to send an INM comprising the CG configuration Information to a first node in the wireless network for configuring at least one UE associated with the first node with measurement gap. Further, the DC measurement gap controller is configured to detect that second node has at least one serving cell is on the FR2 of the wireless network. Further, the DC measurement gap controller is configured to generate a Cell Group (CG) configuration comprising at least one of not allowed preconfigured measurement gap allowed, a maximum number of measurement gaps created by the second node as zero, and a maximum number of network controlled small gap (NCSG) as zero. Further, the DC measurement gap controller is configured to send an INM comprising the CG configuration to the first node for configuring the at least one UE associated with the first node with measurement gap.

Accordingly, the embodiment herein is to provide a first node for handling measurement gap during dual connectivity operation in a wireless network. The first node includes a DC measurement gap controller communicatively coupled to a memory and a processor. Further, the DC measurement gap controller is configured to receive an INM comprising a CG configuration Information from a second node in the wireless network, wherein the CG configuration comprises at least one of allowed preconfigured measurement gap, a maximum number of measurement gaps created by the second node, and a maximum number of NCSG. Further, the DC measurement gap controller configures at least one UE associated with the first node with at least one of the allowed preconfigured measurement gap on the FR2 of the wireless network, the multiple measurement gaps on the FR2 of the wireless network, and NCSG on the FR2 of the wireless network. Further, the DC measurement gap controller is configured to receive an INM comprising a CG configuration from the second node when at least one serving cell is added on the FR2 of the wireless network, wherein the CG configuration comprises at least one of not allowed preconfigured measurement gap, a maximum number of measurement gaps created by the second node as zero, and a maximum number of NCSG as zero. Further, the DC measurement gap controller is configured to release at least one of the not allowed preconfigured measurement gap created on the FR2 of the wireless network, the multiple measurement gaps created on the FR2 of the wireless network, and the multiple NCSG created on the FR2 of the wireless network. Further, the DC measurement gap controller is configured to create the at least one UE associated with the first node with a single measurement gap on the FR2 of the wireless network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In wireless technologies like fifth generation (5G) New Radio (NR) and 4G Long Term Evolution (LTE), a Radio Resource Control (RRC) connected User Equipment (UE) performs various measurements for Radio Resource Management (RRM) purpose, positioning etc. For RRM, the UE measures the reference signals such as Secondary Synchronization Block (SSB), Channel State Information-Reference Signal (CSI-RS) etc. and reports to the network.

According to the NR specifications, for instance, Release 16 TS 38.300 specification, measurements to be performed by the UE for connected mode mobility are classified in at least four measurement types:
1. Intra-frequency NR measurements;
2. Inter-frequency NR measurements;
3. Inter-RAT measurements for E-UTRA; and
4. Inter-RAT measurements for UTRA.

For each measurement type one or several measurement objects can be defined (a measurement object defines e.g. the carrier frequency to be monitored). For each measurement object one or several reporting configurations can be defined (a reporting configuration e.g. defines the reporting criteria). Three reporting criteria are used: event triggered reporting, periodic reporting and event triggered periodic reporting. The association between a measurement object and a reporting configuration is created by a measurement identity (a measurement identity links together one measurement object and one reporting configuration of the same radio access technology (RAT)). The measurements identity is used as well when reporting the measurements.

For positioning purposes the UE may report SSB/CSI-RS measurements and may also report measurements based on additional reference signals like Positioning Reference Signal (PRS).

When the UE needs to measure inter frequency NR or inter-Radio Access Technology (RAT) measurements or intra frequency measurements outside the active downlink (DL) Band Width Part (BWP), when SSB is not completely contained in the active DL BWP, the UE may use measurement gaps. Measurement gaps are configured by the network entity (for e.g. gNB in NR) and there will not be any transmission or reception between the network and UE during the gap period. During a measurement gap, UE may perform random access, but doesn't perform any other transmission or reception. Measurement gap configuration includes a gap offset, gap length, and repetition period and measurement gap timing advance. Gap offset specifies the subframe (and/or slot) where the measurement gap occurs. Gap length gives the duration of the gap while the repetition period defines how often the measurement gap can occur. 3GPP has defined a number of measurement gap patterns—Each gap pattern corresponds to a gap length and a gap repetition period. For e.g. in NR Release 16, there are 26 gap patterns defined. Measurement gap timing advance (mgta) specifies a timing advance value in milliseconds. Gap occurs mgta milliseconds before the subframe given by the measurement gap offset.

In the Release 16 versions of NR specification, the UE may be configured with maximum one measurement gap at any time. Measurement gaps are activated immediately after the configuration, from the measurement gap offset that comes after the reconfiguration. This leads to restrictions for the UE and network implementation.

Similar to measurement gaps, in a multi-USIM (also termed as MUSIM) device, network may configure gaps in a connected mode device for the operation of an idle/inactive mode device which uses other USIM (Universal Subscriber Identity Module). The embodiments captured in this disclosure for measurement gap enhancements can be applied to multi sim gaps also. Further, measurements gap configuration as described in the embodiments in the disclosure are also applicable to Dual-Rx/Dual-Tx UEs, which may undergo SCG deactivation/activation/suspension/release and/or change in number of Rx/Tx links and/or capability for the supported band combinations/compatible band combinations and/or frequency ranges etc.

Dual Connectivity-Dual Connectivity or more technically Multi-Radio Dual Connectivity (MR-DC) is specified by 3GPP in specifications such as TS 37.340. A summary of the details on dual connectivity and measurement gap operations with dual connectivity based on 3gpp specifications are given below.

NG-RAN supports Multi-Radio Dual Connectivity operation whereby a user equipment (UE) in RRC_CONNECTED state is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node acts as the master node (MN) and the other as the secondary node (SN). The MN and SN are connected via a network interface and at least the MN is connected to the core network. NG-RAN supports NG-RAN E-UTRA-NR Dual Connectivity (NGEN-DC), in which a UE is connected to one ng-eNB (a E-UTRA base station that can connect to 5G core) that acts as a MN and one gNB (5G base station) that acts as a SN. NG-RAN also supports NR-E-UTRA Dual Connectivity (NE-DC), in which a UE is connected to one gNB that acts as a MN and one ng-eNB that acts as a SN. The NG-RAN supports a NR-DC where both MN and SN are gNBs. The MN and the SN can be connected using Xn (between gNB-gNB, gNB-ngeNB or ngeNBngeNB) or X2 (gNB-eNB or eNB-cNB) interface. The MN and the SN communicate with each other using Xn/X2 messages. Inter Node RRC Messages between the MN and the SN may be included within X2/X2 messages. CG-ConfigInfo is an INM send by the MN to the SN. CG-Config is an INM send by the SN to the MN.

Measurement Gaps with Dual Connectivity—In release 16 version of 3gpp specifications, Per-UE or per-FR (Frequency Range) measurement gaps can be configured, depending on UE capability to support independent FR measurement and network preference. Per-UE gap applies to both FR1 (E-UTRA, UTRA-FDD and NR) and FR2 (NR) frequencies. For per-FR gap, two independent gap patterns (i.e. FR1 gap and FR2 gap) are configured for FR1 and FR2respectively. The UE may also be configured with a per-UE gap sharing configuration (applying to per-UE gap) or with two separate gap sharing configurations (applying to FR1 and FR2 measurement gaps respectively).

A measurement gap configuration is always provided till release 16 NR in all the following scenarios:
1. In EN-DC, NGEN-DC and NE-DC, for UEs configured with E-UTRA inter-frequency measurements
2. In EN-DC and NGEN-DC, for UEs configured with UTRAN and GERAN
3. In NR-DC, for UEs configured with E-UTRAN measurements
4. In NR-DC, NE-DC, for UEs configured with UTRAN measurements
5. In MR-DC, for UEs that support either per-UE or per-FR gaps, when the conditions to measure SSB based inter-frequency measurement or SSB based intra-frequency measurement as described in TS 38.300 are met.

If per-UE gap is used, the MN decides the gap pattern and the related gap sharing configuration. If per-FR gap is used, in EN-DC and NGEN-DC, the MN decides the FR1 gap pattern and the related gap sharing configuration for FR1, while the SN decides the FR2 gap pattern and the related gap sharing configuration for FR2; in NE-DC and NR-DC, the MN decides both the FR1 and FR2 gap patterns and the related gap sharing configurations. In EN-DC and NGEN-DC, the measurement gap configuration from the MN to the UE indicates if the configuration from the MN is a per-UE gap or an FR1 gap configuration. The MN also indicates the configured per-UE or FR1measurement gap pattern and the gap purpose (per-UE or per-FR1) to the SN.

Measurement gap configuration assistance information can be exchanged between the MN and the SN. For the case of per-UE gap, the SN indicates to the MN the list of SN configured frequencies in FR1 and FR2 measured by the UE. For the per-FR gap case, the SN indicates to the MN the list of SN configured frequencies in FR1 measured by the UE and the MN indicates to the SN the list of MN configured frequencies in FR2 measured by the UE. In NE-DC, the MN indicates the configured per-UE or FR1 measurement gap pattern to the SN. The SN can provide a gap request to the MN, without indicating any list of frequencies. In NR-DC, the MN indicates the configured per-UE, FR1 or FR2 measurement gap pattern and the gap purpose to the SN. The SN can indicate to the MN the list of SN configured frequencies in FR1 and FR2 measured by the UE. In dual connectivity, both MN and SN need to be synchronised about measurement gaps, at least when both of them have same FR type. For e.g. if a per-UE gap is allocated by MN, there shouldn't be transmission and reception from MN and SN during the measurement gap. i.e. both MN and SN shouldn't transmit or receive at the same time which means that SN should be aware of the gap allocated by MN. Behaviour for the per-FR gaps also should be the same.

Thus, it is desired to address the above mentioned disadvantages or other shortcomings or at least provide a useful alternative.

Accordingly the embodiment herein is to provide a method for handling measurement gap(s) during a dual connectivity operation in a wireless network. The method includes detecting, by a first node in the wireless network, whether the first node has capability to support one of a preconfigured measurement gap, multiple measurement gaps, a network controlled small gap (NCSG), a maximum number of multiple measurement gaps and a maximum number of NCSG. The preconfigured measurement gap, multiple measurement gap, network controlled small gap (NCSG) etc. may be referred to as measurement gap enhancements. The capability detected for the measurement gap enhancements by the first node could be also the capability of the first node to support measurement gap enhancements during a dual connectivity operation. For e.g. in some cases, the first node may support measurement gap enhancements when it operates in single connectivity mode, but doesn't support the same when it operates in dual connectivity mode.

Further, the method includes generating, by a first node, a CellGroup (CG) configuration comprising a first node capability when the first node has capability to support one of the preconfigured measurement gap, the multiple measurement gaps, and the NCSG. Further, the method includes sending, by the first node, an Inter-Node Message (INM) comprising the CG configuration including the first node capability to a second node in the wireless network to configure measurement gap for at least one User Equipment (UE) associated with the second node. Further, the method includes receiving, by the first node, an Inter-Node Message (INM) comprising a CG configuration information from the second node, wherein the CG configuration information comprises information of the measurement gap created for the at least one UE.

The proposed method can be used to support the measurement gap enhancements in a dual connectivity, so as to enable the optimal measurement gap configuration leading to increased NR performance for DC in the wireless network.

NR release 17 introduces the support of multiple measurement gaps which can be either concurrent or independent, preconfigured gaps and/or network configured small gaps. They can be called as collectively as New Radio (NR) measurement gap enhancements. There are various problems for supporting any of these features in dual connectivity as given below.

It is possible that only one of Master Node (MN) and Secondary Node (SN) supports one or more of these features. Since measurement gaps require coordination between the nodes in DC (dual connectivity), there is a need of method for handling the case where only one node supports the features.

As described in the background, the MN is responsible for deciding and configuring most of the gaps while SN is responsible for configuring per-FR2 gaps for EN-DC/NG-EN-DC. Since there can be restriction for the maximum number of measurement gaps configured, the maximum number of measurement gaps activated and the total number of gaps and network controlled small gaps configured or activated at the same time, a method for co-ordination of number of gaps is needed.

Pre-configured measurement gaps can be activated based on various actions like BWP switch (due to timer expiry or reception of DCI, RRC based switch or MAC based switch), SCell activation/deactivation, SpCell activation/deactivation etc. When the preconfigured measurement gaps are applicable for both MN and SN and the action that activates or deactivates the preconfigured gap is performed by any one node, we need methods for the other node to be informed and synchronized.

Referring now to the drawings and more particularly to FIGS. 1 through 17, where similar reference characters denote corresponding features consistently throughout the figures, there are shown preferred embodiments.

FIG. 1 illustrates a wireless network (1000) for handling measurement gap during dual connectivity operation, according to the embodiments as disclosed herein. For all the below embodiments, let us consider the case of two nodes in dual connectivity-Node1 (i.e., first node) and Node2 (i.e., second node). The first node allocates gaps (EN-DC/Ng-ENDC for FR2 gaps) and the second node allocates gaps (all other cases).

In an embodiment, the wireless network (1000) includes a first node (100), a second node (200) and a UE (300). The first node (100) is a secondary node (SN) and the second node (200) is a master node (MN). The UE (300) can be, for example, but not limited to a cellular phone, a smart phone, a Personal Digital Assistant (PDA), a tablet computer, a laptop computer, an Internet of Things (IoT), embedded systems, edge devices, a vehicle to everything (V2X) device or the like.

In an example embodiment, the first node (100) detects that the first node (100) has capability to support one of the preconfigured measurement gap, the multiple measurement gaps, the network controlled small gap (NCSG), the maximum number of multiple measurement gaps and the maximum number of NCSG. The first node may detect its capability based on the configurations provided from the operator, for e.g. through configuration files or Operations And Maintenance (OAM) modules. Alternately, first node may detect the capability based on its software implementation, for e.g. by default the measurement gap enhancements may be disabled in its software.

Further, the first node (100) generates the a configuration (e.g., CG configuration or the like) comprising the first node capability when the first node (100) has capability to support one of the preconfigured measurement gap, the multiple measurement gaps, and the NCSG.

Further, the first node (100) sends the INM comprising the configuration including the first node capability to the second node (200) to configure measurement gap for the at least one UE (300) associated with the second node (200). The second node (200) receives the INM comprising the configuration (e.g., CG configuration or the like) from the first node (100) to configure measurement gap for at least one User Equipment (UE) (300) associated with the second node (200) with measurement gap. The second node (200) creates the at least one UE (300) with the measurement gap for the at least one UE (300) based on the CG configuration. The second node (200) sends the INM comprising a configuration information (e.g., CG configuration information or the like) to the first node (100). The configuration information comprises information of the measurement gap created for the at least one UE. Further, the first node (100) receives the INM comprising the CG configuration information from the second node (200). The INM send by the first node (100) is a CG configuration, and the INM send by the second node (200) is a CG configuration information.

Further, the first node (100) generates the CG configuration comprising the list of frequencies to be configured for measurements by the first node (100) and multiple measurement gaps to be created by the second node (200) for those frequencies, whether preconfigured measurement gap is preferred or required for those measurement gaps and status of the activation status of the preconfigured measurement gap. Further, the first node (100) sends the INM comprising the CG Config configuration to the second node (200) for configuration of the multiple measurement gaps for the at least one UE (300). Further, the first node (100) receives the INM comprising the CG configuration information from the second node (200). The CG configuration information comprises the multiple measurement gaps created by the second node (200) for the at least one UE (300), a mapping of the multiple measurement gaps to at least one frequency of the list of frequencies supported by the first node (100), the type of multiple measurement gaps for identifying the multiple measurement gaps as preconfigured or not and the activation status of the preconfigured multiple measurement gaps.

Further, the first node (100) detects the at least one of the bandwidth part (BWP) switch, a secondary cell addition, a secondary cell activation, and a secondary cell group (SCG) activation. Further, the first node (100) generates the INM comprising one of CG Config comprising the status indicating activation of at least one preconfigured measurement gap from the multiple measurement gaps based on the at least one of the BWP switch, the secondary cell addition, the secondary cell activation, and the SCG activation. Further, the first node (100) sends the INM comprising a CG Config to the second node (200) for activation of the at least one preconfigured measurement gap for the at least one UE (300). Further, the first node (100) receives the INM comprising the CG configuration information from the second node (200), where the CG configuration information indicates activation of the at least one measurement gap for the at least one UE (300) by the second node (200). Further, the first node (100) activates the at least one measurement gap for the at least one UE (300) in response to receiving the CG configuration information from the second node (200).

Further, the first node (100) detects the at least one of the BWP switch, the secondary cell release, the secondary cell deactivation, and the SCG deactivation. Further, the first node (100) generates the INM comprising the CG Config comprising a status indicating deactivation of the at least one measurement gap based on the at least one of the BWP switch, the secondary cell release, the secondary cell deactivation, and the SCG deactivation. Further, the first node (100) sends the INM comprising the CG Config to the second node (200) indicating deactivation of the at least one measurement gap for the at least one UE (300). Further, the first node (100) receives the INM comprising the CG configuration information from the second node (200), where the CG configuration information indicates deactivation of the at least one measurement gap for the at least one UE (300) by the second node (200). Further, the first node (100) deactivates the at least one measurement gap for the at least one UE (300) in response to receiving the CG configuration information from the second node (200).

Further, the first node (100) receives the INM comprising the CG configuration information about activation of the at least one measurement gap for the at least one UE (300) by the second node (200) when the second node (200) detects at least one of the BWP switch, the secondary cell addition, the secondary cell activation, and the SCG activation. Further, the first node (100) activates the at least one measurement gap for the at least one UE (300) in response to receiving the CG configuration information from the second node (200).

Further, the first node (100) receives the INM comprising the CG configuration information about deactivation of the at least one measurement gap for the at least one UE (300) by the second node (200) when the second node (200) detects at least one of the BWP switch, the secondary cell release, the secondary cell deactivation, and the SCG deactivation. Further, the first node (100) deactivates the at least one measurement gap for the at least one UE (300) in response to receiving the CG configuration information from the second node (200).

In another embodiments, the first node (100) receives the INM including the CG configuration information from the second node (200). The CG configuration comprises at least one of allowed preconfigured measurement gap, a maximum number of measurement gaps created by the second node (200), and a maximum number of network controlled small gap (NCSG). Further, the first node (100) configures the at least one UE (300) associated with the first node (100) with at least one of the allowed preconfigured measurement gap on the FR2 of the wireless network (1000), the multiple measurement gaps on the FR2 of the wireless network (1000), and NCSG on the FR2 of the wireless network (1000). Further, the first node (100) receives the INM comprising the CG configuration from the second node (200) when at least one serving cell is added on the FR2 of the wireless network (1000). The CG configuration includes at least one of preconfigured measurement gap as not allowed, a maximum number of measurement gaps created by the second node as zero, and a maximum number of NCSG as zero. Further, the first node (100) releases the at least one of the not allowed preconfigured measurement gap created on the FR2 of the wireless network (1000), the multiple measurement gaps created on the FR2 of the wireless network (1000), and the multiple NCSG created on the FR2 of the wireless network. Further, the first node (100) creates the at least one UE (300) associated with the first node (100) with the single measurement gap on the FR2 of the wireless network (1000).

Further, the first node (100) receives the INM comprising a CG Config configuration from the second node (200) for configuration of the multiple measurement gaps for the at least one UE (300). The CG configuration includes measurement gap on the FR2 is allowed and the NCSG on the FR2 is allowed. Further, the first node (100) creates the measurement gap on the FR2 and the NCSG on the FR2 within the limits as configured by the second node (200). Further, the first node (100) sends the INM comprising the CG configuration information to the second node (200). The CG configuration information includes the multiple measurement gaps created on the FR2 by the first node (100) for the at least one UE, and the NCSG created on the FR2 by the first node (100).

The SN informing the support of the NR measurement gap enhancements to node configuring measurement gaps to the MN:

In an embodiment, the first node informs its capability of NR measurement gap enhancement features—i.e. support of multiple measurement gaps, preconfigured gaps and NCSG to the second node.

In an embodiment, the first Node is SN and the second Node is MN and an inter node RRC message is used for transferring the information. Inter node RRC message can be CG-config as defined in 3GPPNR specifications. In an alternate embodiment, rather than using RRC inter node messages, the first Node may inform the capability in Xn/X2 messages—for e.g. during procedures like Xn setup/X2 setup/SgNB Addition Request/S-Node Addition Request/NG-RAN node/eNB configuration update/SgNB/S-Node modification request. The Xn messages or X2 messages may not be standardised messages, but any message between the nodes such as gNB-gNB, gNB-ng-cNB, ng-cNB-ng-cNB or Gnb-Enb. If both the nodes are collocated, they may be IPC (Inter-Process Communication) messages. In some cases, capabilities are exchanged. In some cases, the capabilities of the first node may be configured in the second node directly, by OAM or operator instead of exchanging using INM.

As in the case of other optional capabilities in RRC, if the capabilities are absent in the message, receiving node understands that the sending node doesn't support the capability.

Capabilities informed by the first Node in the above embodiment may include whether the first Node supports multiple measurement gaps, preconfigured gaps and NCSG. Capability also may include the maximum number of gaps supported—for e.g. maximum number of measurement gaps, maximum number of NCSG, maximum number of measurement gaps and NCSG together, maximum number of preconfigured gaps, maximum number of per UE (300) or per FR gaps etc. In an extended embodiment, the first Node may indicate if it supports NR measurement enhancement features separately for per UE gaps, perFR1 gaps, perFR2 gaps, separate bands etc. An example RRC Inter-Node Message (INM) specification including the additional information is given below—

CG-Config-v1710-IEs ::= SEQUENCE {
...
preconfiguredGapSupport ENUMERATED {false, true} OPTIONAL,
maxNumGapSupportINTEGER(1..maxNumGps
) OPTIONAL,
maxNumNCSGSupportedINTEGER(1..maxNumGps
) OPTIONAL,
...
}

In another embodiment, the MN performs the following actions using the information received from SN. Before dual connectivity is established, MN configures UE (300) with multiple measurement gaps/preconfigured gap/NCSG. On addition of dual connectivity, if SN doesn't support multiple measurement gaps/preconfigured gap/NCSG as indicated in CG-Config, MN reconfigures the UE (300) with a single measurement gap/legacy gap. In a specific embodiment, MN checks and confirms if the measurement gaps are per UE gaps or per FR gap and at least one serving cell in SN has a frequency in the same FR in SN before performing aforesaid reconfiguration. The MN may reconfigure the UE with a single measurement gap which is not a preconfigured gap or NCSG if it doesn't support measurement gap enhancements and dual connectivity together.

The MN configuring whether NR measurement gap enhancements can be used and various properties of measurement gap enhancements by the SN: In another embodiment, the second Node informs the first Node whether the first Node can configure preconfigured gaps, NCSG, multiple measurement gaps and multiple NCSG. The second Node may also indicate number of multiple measurement gaps and multiple NCSG second node can configure.

In an embodiment, the first Node is the SN, the second Node is MN, deployment type is EN-DC/Ng-EN-DC, gap type is perFR2 gap and an inter node RRC message is used for transferring the information. Inter node RRC message can be CG-ConfigInfo. In an alternate embodiment, rather than using RRC inter node messages, Xn/X2 messages—for e.g. during procedures like Xn setup/X2 setup/SgNB Addition Request/S-Node Addition Request/NG-RAN node/eNB configuration update/SgNB/S-Node modification request may be used.

The second node derives the decision on whether to allow the first Node to configure enhanced measurement feature based on one or more of the UE capabilities, the second Node capabilities for enhanced measurement features, the second Node internal configuration and the first Node capabilities for enhanced measurement features which may be received according to earlier embodiments.

An example RRC Inter-Node Message (INM) specification including the additional information as above embodiment is given below—

CG-ConfigInfo-v1710-IEs ::= SEQUENCE {
...
preconfiguredGapAllowed ENUMERATED {false,true} OPTIONAL,
maxNumFR2GapAllowedINTEGER(1..maxNumGaps
) OPTIONAL,
MaxNumFR2NCSGAllowedINTEGER(1..maxNumNCSG
) OPTIONAL,
...
}

Consider the case where MN doesn't support multiple per FR2 gaps, preconfigured gaps and NCSG while SN and UE supports all the three. If MN doesn't have a serving cell on any FR2 frequency, MN sends a non-zero value (for example maxNumGaps) for maxNumberFR2GapAllowed to SN. MN also sends preconfigured GapAllowed to SN as true. MN also may indicate NCSG can be supported, for e.g. by sending MaxNumFR2NCSGSupported as a nonzero value. SN may configure multiple gaps, preconfigured gaps or NCSG.

On addition of a FR2 serving cell in the MN, the MN sends maxNumFR2GapAllowed and MaxNumFR2NCSGSupported as zero. The MN also sends preconfiguredGapAllowed to SN as false. The SN reconfigures multiple FR2 gaps into a single FR2 gap. If any preconfigured measurement gap is configured, SN converts them to legacy gap. SN also convert any NCSG to legacy measurement gap.

In an alternate embodiment, if one node in dual connectivity doesn't support a feature (multiple gaps/preconfigured gaps/ncsg), both the nodes will configure the UE (300) with legacy measurement gap mechanism during dual connectivity. For e.g. if SN doesn't support preconfigured gaps, MN may decide not to configure it for the UE even for the gaps which doesn't include SN involvement. Similarly, if the MN doesn't support measurement gap enhancements when it is in dual connectivity it will configure the UE with legacy measurement gap during dual connectivity, and may send RRC reconfiguration to the UE (300) by reconfiguring the enhanced measurement gaps to legacy gaps.

Coordination on the multiple gaps and mapped frequencies, pre-configuration info between nodes. The first Node informs the second node at least one of the frequencies to be measured, whether pre-configuration of gaps is preferred/required for the frequency measurement and the initial activation status required for the preconfigured gaps for the frequency. The second node maps the measurement gaps/NCSG to one or more frequencies and informs the first Node. The second Node may also configure one or more measurement gaps as preconfigured gaps and informs the configured activation status to the first Node.

In an embodiment, the first Node is SN and the second Node is MN, deployment type is NR-DC or NG-EN-DC and the gap type is per-FR1 gap or per-UE gap. An inter node RRC message like CG-Config is sent by the second Node for transferring the list of frequencies and associated information. The first Node may send an inter Node RRC message like CG-Config-Info to inform the mapping of multiple measurement gaps to the second Node frequencies, and the activation status of preconfigured gaps.

In an embodiment the second Node informs the first node at least one of the frequencies to be measured, whether pre-configuration of gaps is preferred/required for the frequency measurement and the initial activation status required for the preconfigured gaps for the frequency. The first node maps the measurement gaps/NCSG to one or more frequencies and informs the second Node. The first Node may also configure one or more measurement gaps as preconfigured gaps and informs the configured activation status to the second Node.

In the above embodiment, the first Node is SN and the second node is MN, deployment type is EN-DC/NG-ENDC and the gap type is per-FR2. The inter node RRC message like CG-ConfigInfo is sent by the second Node for transferring list of frequencies and associated information. The first Node may send an inter Node RRC message like CG-Config to inform the mapping of multiple measurement gaps to the second Node frequencies, and the activation status of preconfigured gaps.

One possible example for the structures according to above embodiments is given below—

```
  MeasConfigSN ::= SEQUENCE {
  measuredFrequenciesSN SEQUENCE (SIZE (1..maxMeasFreqsSN)) OF NR-
FreqInfo OPTIONAL,
  gapConfig_r17 SEQUENCE (SIZE (1..maxMeasGaps)) OF NR-GapConfig
OPTIONAL,
  ...
  }
  NR-FreqInfo ::= SEQUENCE {
  measuredFrequency ARFCN-ValueNR OPTIONAL,
  required-preconfiguration-r170 ENUMERATED {false,true},
  required-activation-status-r170 ENUMERATED{activated,deactivated}
  ...
  }
  CG-ConfigInfo-IEs ::= SEQUENCE {
  ...
  measConfigMNMeasConfigMN OPTIONAL,
  ...
  }
  MeasConfigMN ::= SEQUENCE {
  measuredFrequenciesMN SEQUENCE (SIZE (1..maxMeasFreqsMN)) OF NR-
FreqInfo OPTIONAL,
  measGapConfigSetupRelease{ GapConfig } OPTIONAL,
  ...,
  [[ measGapConfigFR2 SetupRelease{ GapConfig } OPTIONAL
  ]]
  }
```

If an optional capability is not present or not send, it means that the node doesn't support the capability. The X2/Xn messages or L1/L2 signalling could be also used for transferring this information between nodes instead of inter node RRC messages. L1/L2 signalling will be transferring L1 or L2 messages between nodes.

Coordination of activation status of preconfigured gaps: In another embodiment, on BWP switch or SCG activation/deactivation or SCell activation/deactivation or SCell addition/release at the first Node, the first Node indicates the changed activation status required for the preconfigured gap. The second Node activates or deactivates the preconfigured gap based on the first Node request/indication and informs the first Node.

In yet another embodiment, on BWP switch or SCG activation/deactivation or SCell activation/deactivation or SCell addition/release at the second Node, The second Node may change the activation status of the preconfigured gap and if the same preconfigured gap is applicable for the first Node, inform the first Node the changed activation status. Preconfigured gap is applicable to the first Node if it is a per the UE gap or if it is per FR gap and the first Node also has a serving cell on the same FR.

In an embodiment, the first Node is SN and the second Node is MN, deployment type is NR-DC or NE-DC. In another embodiment, the first Node is the SN and the second Node is the MN, deployment type is EN-DC/NG-ENDC and gap type is per UE gap or perFR1 gap. Changed activation status for the preconfigured gap can be send from the first Node to the second Node in INM message like CG-Config. The second Node confirms the activation status in INM message like CG-ConfigInfo. In an alternate embodiment, L1/L2 signalling like MAC signalling or X2/Xn messages could be used between nodes for communicating either the required activation status or the changed activation status.

In another embodiment, the first Node is SN and the second node is MN, deployment type is EN-DC/NG-EN-DC and the gap type is per-FR2 gap. Changed activation status for the preconfigured gap can be send from the first Node to the second Node in INM message like CG-Config. The second Node confirms the activation status in INM message like CG-ConfigInfo. In an alternate embodiment, L1/L2 signalling like MAC signalling or X2/Xn messages could be used between nodes for communicating either the required activation status or the changed activation status.

Changed activation status in the above embodiments means the new activation status.

A possible example for the message content when inter node RRC signalling is used is given below—

```
  CG-Config-v1710-IEs ::= SEQUENCE {
  .....
  MeasGapInfo_r17 SEQUENCE (SIZE (1..maxMeasGaps)) OF GapInfo_r17
OPTIONAL,
  }
  GapInfo_r17 ::= Sequence {
  measgapId MeasGapId integer,
  mappedFrequencies-r17 Sequence (1...max of maxMeasFreqsMN), OPTIONAL
  activation-status-r17 ENUMERATED {activated,deactivated} OPTIONAL
  }
  CG-Config-v1710-IEs ::= SEQUENCE {
  .....
  MeasGapInfo_r17 SEQUENCE (SIZE (1..maxMeasGaps)) OF GapInfo_r17
OPTIONAL,
  ......
  }
```

Coordination of number of measurement gaps to be allocated, this embodiment involves two steps:

The second node informs the first Node number of measurement gaps or NCSG which can be allocated

The first Node allocates multiple measurement gaps/NCSG and informs the second Node number of gaps/NCSG allocated.

In an embodiment, the first Node is SN and the second Node is MN and the deployment type is EN-DC or NG-ENDC and the gap type is perFR2 gap.

The second Node may send inter-node RRC message like CG-ConfigInfo to inform the first Node of number of measurement gaps that can be allocated. The first Node may send inter-node RRC message like CG-Config to inform the first Node the number of measurement gaps that are actually allocated. X2/Xn message or L2 signalling can be alternately used instead of inter node RRC message.

Possible example for the inter node RRC messages to implement the embodiment are given below.

CG-Config-v1710-IEs ::= SEQUENCE {
...
NumFR2GapConfigured INTEGER(1..maxNumGps
) OPTIONAL,
NumFR2NCSGConfigured INTEGER(1..maxNumGps
) OPTIONAL,
...
}
CG-ConfigInfo-v1710-IEs ::= SEQUENCE {
...
NumFR2GapAllowed INTEGER(1..maxNumGps
) OPTIONAL,
NumFR2NCSGAllowedINTEGER(1..maxNumGps
) OPTIONAL,
...
}

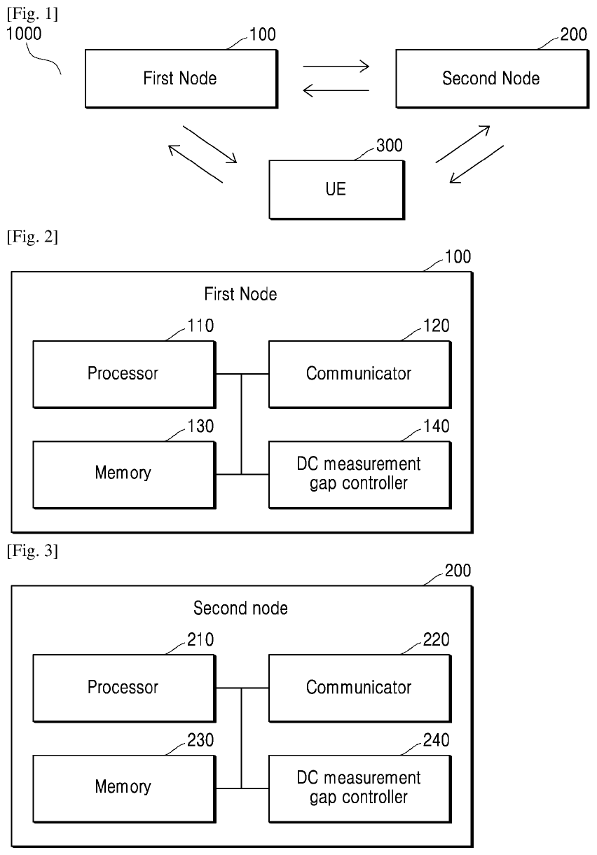

FIG. 2 shows various hardware components of the first node (100), according to the embodiments as disclosed herein. In an embodiment, the first node (100) includes a processor (110), a communicator (120), a memory (130) and a DC measurement gap controller (140). The processor (110) is coupled with the communicator (120), the memory (130) and the DC measurement gap controller (140).

The DC measurement gap controller (140) detects the first node (100) has capability to support one of the preconfigured measurement gap, the multiple measurement gaps, the network controlled small gap (NCSG), the maximum number of multiple measurement gaps and the maximum number of NCSG. Further, the DC measurement gap controller (140) generates a CG configuration comprising the first node capability when the first node (100) has capability to support one of the preconfigured measurement gap, the multiple measurement gaps, and the NCSG. Further, the DC measurement gap controller (140) sends the INM comprising the CG configuration including the first node capability to the second node (200) to configure measurement gap for the at least one UE (300) associated with the second node (200). Further, the DC measurement gap controller (140) receives the INM comprising the CG configuration information from the second node (200). The CG configuration information includes the information of the measurement gap created for the at least one UE (300).

Further, the DC measurement gap controller (140) generates the CG configuration comprising the list of frequencies to be configured for measurements by the first node (100) and multiple measurement gaps to be created by the second node (200) for those frequencies, whether preconfigured measurement gap is preferred or required for those measurement gaps and status of the activation status of the preconfigured measurement gap. Further, the DC measurement gap controller (140) sends the INM comprising the CG Config configuration to the second node (200) for configuration of the multiple measurement gaps for the at least one UE (300). Further, the DC measurement gap controller (140) receives the INM comprising the CG configuration information from the second node (200). The CG configuration information comprises the multiple measurement gaps created by the second node (200) for the at least one UE (300), a mapping of the multiple measurement gaps to at least one frequency of the list of frequencies supported by the first node (100), the type of multiple measurement gaps for identifying the multiple measurement gaps as preconfigured or not and the activation status of the preconfigured multiple measurement gaps.

Further, the DC measurement gap controller (140) detects the at least one of the bandwidth part (BWP) switch, a secondary cell addition, a secondary cell activation, and a secondary cell group (SCG) activation. Further, the DC measurement gap controller (140) generates the INM comprising one of CG Config or CGConfigInfo comprising the status indicating activation of at least one preconfigured measurement gap from the multiple measurement gaps based on the at least one of the BWP switch, the secondary cell addition, the secondary cell activation, and the SCG activation. Further, the DC measurement gap controller (140) sends the INM comprising a CG Config to the second node (200) for activation of the at least one preconfigured measurement gap for the at least one UE (300). Further, the DC measurement gap controller (140) receives the INM comprising the CG configuration information from the second node (200), where the CG configuration information indicates activation of the at least one measurement gap for the at least one UE (300) by the second node (200). Further, the DC measurement gap controller (140) activates the at least one measurement gap for the at least one UE (300) in response to receiving the CG configuration information from the second node (200).

Further, the DC measurement gap controller (140) detects the at least one of the BWP switch, the secondary cell release, the secondary cell deactivation, and the SCG deactivation. Further, the DC measurement gap controller (140) generates the INM comprising the CG Config comprising a status indicating deactivation of the at least one measurement gap based on the at least one of the BWP switch, the secondary cell release, the secondary cell deactivation, and the SCG deactivation. Further, the DC measurement gap controller (140) sends the INM comprising the CG Config to the second node (200) indicating deactivation of the at least one measurement gap for the at least one UE (300). Further, the DC measurement gap controller (140) receives the INM comprising the CG configuration information from the second node (200), where the CG configuration information indicates deactivation of the at least one measurement gap for the at least one UE (300) by the second node (200). Further, the DC measurement gap controller (140) deactivates the at least one measurement gap for the at least one UE (300) in response to receiving the CG configuration information from the second node (200).

Further, the DC measurement gap controller (140) receives the INM comprising the CG configuration information about activation of the at least one measurement gap for the at least one UE (300) by the second node (200) when the second node (200) detects at least one of the BWP switch, the secondary cell addition, the secondary cell activation, and the SCG activation. Further, the DC measurement gap controller (140) activates the at least one measurement gap for the at least one UE (300) in response to receiving the CG configuration information from the second node (200).

Further, the DC measurement gap controller (140) receives the INM comprising the CG configuration information about deactivation of the at least one measurement gap for the at least one UE (300) by the second node (200) when the second node (200) detects at least one of the BWP switch, the secondary cell release, the secondary cell deactivation, and the SCG deactivation. Further, the DC measurement gap controller (140) deactivates the at least one measurement gap for the at least one UE (300) in response to receiving the CG configuration information from the second node (200).

In another embodiments, the DC measurement gap controller (140) receives the INM including the CG configuration information from the second node (200). The CG configuration comprises at least one of allowed preconfigured measurement gap, a maximum number of measurement gaps created by the second node (200), and a maximum number of network controlled small gap (NCSG). Further, the DC measurement gap controller (140) configures the at least one UE (300) associated with the first node (100) with at least one of the allowed preconfigured measurement gap on the FR2 of the wireless network (1000), the multiple measurement gaps on the FR2 of the wireless network (1000), and NCSG on the FR2 of the wireless network (1000). Further, the DC measurement gap controller (140) receives the INM comprising the CG configuration from the second node (200) when at least one serving cell is added on the FR2 of the wireless network (1000). The CG configuration includes at least one of not allowed preconfigured measurement gap, a maximum number of measurement gaps created by the second node as zero, and a maximum number of NCSG as zero. Further, the DC measurement gap controller (140) releases the at least one of the not allowed preconfigured measurement gap created on the FR2 of the wireless network (1000), the multiple measurement gaps created on the FR2 of the wireless network (1000), and the multiple NCSG created on the FR2 of the wireless network. Further, the DC measurement gap controller (140) creates the at least one UE (300) associated with the first node (100) with the single measurement gap on the FR2 of the wireless network (1000).

Further, the DC measurement gap controller (140) receives the INM comprising a CG Config configuration from the second node (200) for configuration of the multiple measurement gaps for the at least one UE (300). The CG configuration includes measurement gap on the FR2 is allowed and the NCSG on the FR2 is allowed. Further, the DC measurement gap controller (140) creates the measurement gap on the FR2 and the NCSG on the FR2 within the limits as configured by the second node (200). Further, the DC measurement gap controller (140) sends the INM comprising the CG configuration information to the second node (200). The CG configuration information includes the multiple measurement gaps created on the FR2 by the first node (100) for the at least one UE, and the NCSG created on the FR2 by the first node (100).

The DC measurement gap controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the first node (100) but it is to be understood that other embodiments are not limited thereon. In other embodiments, the first node (100) may include less or more number of components. Further, the labels or names of the components are used only for illustrative purpose and does not limit the scope of the embodiments in the disclosure. One or more components can be combined together to perform same or substantially similar function in the first node (100).

FIG. 3 shows various hardware components of the second node (200), according to the embodiments as disclosed herein. In an embodiment, the second node (200) includes a processor (210), a communicator (220), a memory (230) and a DC measurement gap controller (240). The processor (210) is coupled with the communicator (220), the memory (230) and the DC measurement gap controller (240).

The DC measurement gap controller (240) receives the INM including the CG configuration from the first node (100) to configure measurement gap for at least one UE (300) associated with the second node (200) with measurement gap. Further, the DC measurement gap controller (240) creates the at least one UE (300) with the measurement gap for the at least one UE (300) based on the CG configuration. Further, the DC measurement gap controller (240) sends the INM comprising the CG configuration information to the first node (100).

Further, the DC measurement gap controller (240) determines whether the measurement gaps are per UE gaps or per FR gap and at least one serving cell in the first node (100) has the frequency in same FR in the first node (100). Further, the DC measurement gap controller (240) creates the at least one UE (300) with at least one of the preconfigured measurement gap, the multiple measurement gaps, and the NCSG based on the measurement gaps are per UE gaps or per FR gap and at least one serving cell in the first node (100) has a frequency in same FR in the first node (100).

Further, the DC measurement gap controller (240) creates the at least one UE (300) with at least one of the preconfigured measurement gap, the multiple measurement gaps based on the maximum number of multiple measurement gaps, and the NCSG when no dual connectivity is established. Further, the DC measurement gap controller (240) determines the addition of the first node (100) and establishment of the dual connectivity. Further, the DC measurement gap controller (240) determines whether the CG configuration includes the first node capability to support at least one of the preconfigured measurement gap, the multiple measurement gaps, the NCSG, the maximum number of multiple measurement gaps and the maximum number of NCSG. Further, the DC measurement gap controller (240) reconfigures the at least one UE (300) with the single measurement gap when at least one of the dual connectivity is established and the CG configuration does not include first node capability to support at least one of the preconfigured measurement gap, the multiple measurement gaps, and the NCSG.

Further, the DC measurement gap controller (240) receives the INM comprising the CG configuration from the first node (100) for configuration of the multiple measurement gaps for the at least one UE (300) associated with the second node (200). The CG configuration comprises the list of frequencies supported by the first node (100) and multiple measurement gaps to be created by the second node (200), and a status of the multiple measurement gaps to be activated by the second node (200). Further, the DC measurement gap controller (240) creates the multiple measurement gaps for the at least one UE (300) by mapping the multiple measurement gaps to the list of frequencies supported by the first node and marking the status of the multiple measurement gaps as active by the second node. Further, the DC measurement gap controller (240) sends the INM including the CG configuration information to the first node (100). The CG configuration information comprises information of the multiple measurement gaps created by the second node (200) for the at least one UE (300), the mapping of the multiple measurement gaps to at least one frequency of the list of frequencies supported by the first node (100), type of multiple measurement gaps for identifying the multiple measurement gaps as preconfigured or not and the activation status of the created multiple preconfigured measurement gaps.

Further, the DC measurement gap controller (240) detects the at least one of a bandwidth part (BWP) switch, the secondary cell addition, the secondary cell activation, and the SCG activation. Further, the DC measurement gap controller (240) activates the at least one measurement gap based on at least one of the BWP switch, the secondary cell addition, the secondary cell activation, and the SCG activation. Further, the DC measurement gap controller (240) sends the INM comprising the CG configuration information to the first node (100). The CG configuration information indicates activation of the at least one measurement gap for the at least one UE (300) by the second node (200).

Further, the DC measurement gap controller (240) detects the at least one of the BWP switch, the secondary cell release, the secondary cell deactivation, and the SCG deactivation. Further, the DC measurement gap controller (240) deactivates the at least one measurement gap based on at least one of the BWP switch, the secondary cell release, the secondary cell deactivation, and the SCG deactivation. Further, the DC measurement gap controller (240) sends the INM comprising the CG configuration information to the first node (100), where the CG configuration information indicates deactivation of the at least one measurement gap for the at least one UE (300) by the second node (200).

Further, the DC measurement gap controller (240) receives the INM comprising the CG configuration information about activation of the at least one measurement gap for the at least one UE by the second node (200) when the first node (100) detects at least one of a BWP switch, the secondary cell addition, the secondary cell activation, and the SCG activation. Further, the DC measurement gap controller (240) activates the at least one measurement gap for the at least one UE (300) in response to receiving the CG configuration information from the first node (100). Further, the DC measurement gap controller (240) sends the INM comprising the CG configuration information to the first node (100), where the CG configuration information indicates deactivation of the at least one measurement gap for the at least one UE (300) by the second node (200).

Further, the DC measurement gap controller (240) receives the INM comprising the CG configuration information about deactivation of the at least one measurement gap for the at least one UE (300) by the second node (200) when the first node (100) detects the at least one of the BWP switch, the secondary cell release, the secondary cell deactivation, and the SCG deactivation. Further, the DC measurement gap controller (240) deactivates the at least one measurement gap for the at least one UE (300) in response to receiving the CG configuration information from the first node (100). Further, the DC measurement gap controller (240) sends the INM comprising a CG configuration information to the first node (100), where the CG configuration information indicates deactivation of the at least one measurement gap for the at least one UE by the second node (200).

In another embodiment, the DC measurement gap controller (240) detects if the second node (200) has any serving cell on the FR2 of the wireless network (1000). Further, the DC measurement gap controller (240) generates the CG configuration information comprising at least one of allowed preconfigured measurement gap, a maximum number of measurement gaps allowed to be created by the first node (100), and a maximum number of NCSG allowed to be created by the first node (100) when the second node (200) has no serving cell on the FR2 of the wireless network (1000). Further, the DC measurement gap controller (240) sends the INM comprising the CG configuration information to the first node (100) for configuring at least one UE (300) associated with the first node (100) with measurement gap. Further, the DC measurement gap controller (240) detects that the second node (200) has at least one serving cell is on the FR2 of the wireless network (1000). Further, the DC measurement gap controller (240) generates the CG configuration comprising at least one of not allowed preconfigured measurement gap allowed, a maximum number of measurement gaps created by the second node as zero, and a maximum number of network controlled small gap (NCSG) as zero. Further, the DC measurement gap controller (240) sends the INM comprising the CG configuration to the first node (100) for configuring the at least one UE associated with the first node (100) with measurement gap.

Further, the DC measurement gap controller (240) generates the CG configuration comprising number of measurement gaps on the FR2 allowed and the number of NCSG on the FR2 allowed. Further, the DC measurement gap controller (240) sends the INM comprising the CG Config configuration to the first node (100) for configuration of the multiple measurement gaps for the at least one UE (300). Further, the DC measurement gap controller (240) receives the INM comprising a CG configuration information from the first node (100), where the CG configuration information comprises the multiple measurement gaps created on the FR2 by the first node for the at least one UE (300), and the multiple NCSG created on the FR2 by the first node (100).

The DC measurement gap controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the second node (200) but it is to be understood that other embodiments are not limited thereon. In other embodiments, the second node (200) may include less or more number of components. Further, the labels or names of the components are used only for illustrative purpose and does not limit the scope of the embodiments in the disclosure. One or more components can be combined together to perform same or substantially similar function in the second node (200).

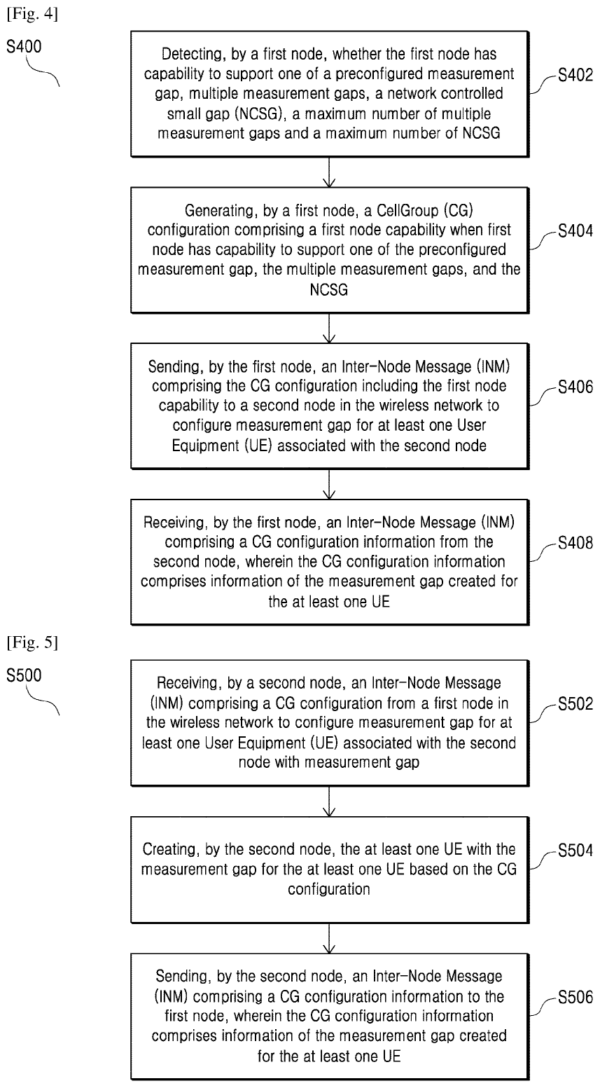

FIG. 4 is a flow chart (S400) illustrating a method, implemented by the first node (100), for handling the measurement gap during the dual connectivity operation in the wireless network (1000), according to the embodiments as disclosed herein. The operations (S402-S408) are handled by the DC measurement gap controller (140).

At S402, the method includes detecting whether the first node (100) has capability to support one of the preconfigured measurement gap, the multiple measurement gaps, the NCSG, the maximum number of multiple measurement gaps and the maximum number of NCSG. At S404, the method includes generating a CellGroup (CG) configuration comprising the first node capability when the first node (100) has capability to support one of the preconfigured measurement gap, the multiple measurement gaps, and the NCSG. At S406, the method includes sending the INM comprising the CG configuration including the first node capability to the second node (200) in the wireless network (1000) to configure measurement gap for at least one User Equipment (UE) (300) associated with the second node (200). At S408, the method includes receiving the INM comprising the CG configuration information from the second node (200). The CG configuration information includes information of the measurement gap created for the at least one UE (300).

FIG. 5 is a flow chart (S500) illustrating a method, implemented by the second node (200), for handling the measurement gap during the dual connectivity operation in the wireless network (1000), according to the embodiments as disclosed herein. The operations (S502-S506) are handled by the DC measurement gap controller (240).

At S502, the method includes receiving the INM comprising the CG configuration from the first node (100) to configure measurement gap for at least one UE (300) associated with the second node (200) with measurement gap. At S504, the method includes creating the at least one UE (300) with the measurement gap for the at least one UE (300) based on the CG configuration. At S506, the method includes sending the INM comprising the CG configuration information to the first node (100). The CG configuration information includes information of the measurement gap created for the at least one UE (300).

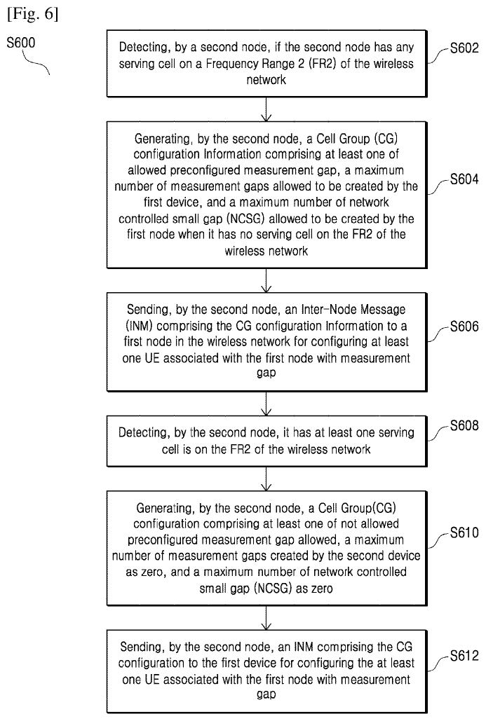

FIG. 6 is another flow chart (S600) illustrating a method, implemented by the second node (200), for handling the measurement gap during the dual connectivity operation in the wireless network (1000), according to the embodiments as disclosed herein. The operations (S602-S612) are handled by the DC measurement gap controller (240).

At S602, the method includes detecting if the second node (200) has any serving cell on a Frequency Range 2 (FR2) of the wireless network. At S604, the method includes generating the CG configuration information comprising at least one of allowed preconfigured measurement gap, the maximum number of measurement gaps allowed to be created by the first device (100), and a maximum number of network controlled small gap (NCSG) allowed to be created by the first node (100) when the second node (200) has no serving cell on the FR2 of the wireless network (1000).

At S606, the method includes sending the INM comprising the CG configuration information to the first node (100) for configuring at least one UE (300) associated with the first node (100) with measurement gap. At S608, the method includes detecting that the second node (200) has at least one serving cell is on the FR2 of the wireless network. At S610, the method includes generating the Cell Group (CG) configuration comprising at least one of not allowed preconfigured measurement gap allowed, a maximum number of measurement gaps created by the second device (200) as zero, and the maximum number of network controlled small gap (NCSG) as zero. At S612, the method includes sending the INM comprising the CG configuration to the first node (100) for configuring the at least one UE (300) associated with the first node (100) with measurement gap.

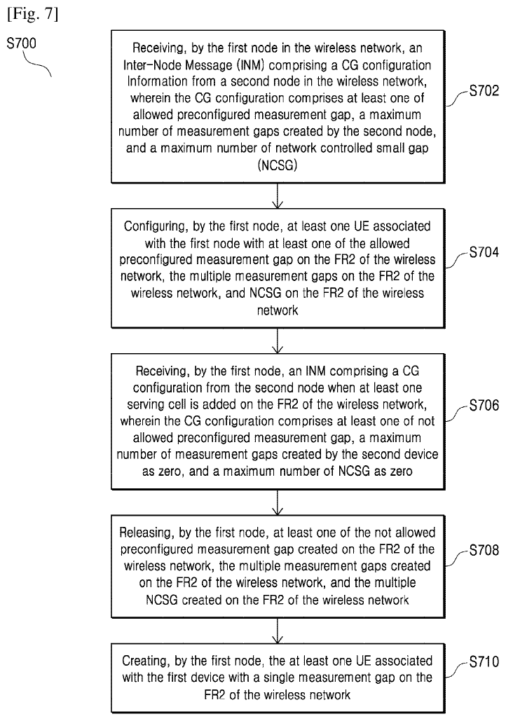

FIG. 7 is another flow chart (S700) illustrating a method, implemented by the first node (100), for handling the measurement gap during the dual connectivity operation in the wireless network (1000), according to the embodiments as disclosed herein. The operations (S702-S710) are handled by the DC measurement gap controller (140).

At S702, the method includes receiving the INM comprising the CG configuration Information from the second node (200), where the CG configuration includes at least one of allowed preconfigured measurement gap, the maximum number of measurement gaps created by the second node (200), and the maximum number of network controlled small gap (NCSG). At S704, the method includes configuring at least one UE (300) associated with the first node (100) with at least one of the allowed preconfigured measurement gap on the FR2 of the wireless network (1000), the multiple measurement gaps on the FR2 of the wireless network (1000), and NCSG on the FR2 of the wireless network (1000).

At S706, the method includes receiving the INM comprising the CG configuration from the second node (200) when at least one serving cell is added on the FR2 of the wireless network (1000), wherein the CG configuration comprises at least one of not allowed preconfigured measurement gap, the maximum number of measurement gaps created by the second node as zero, and a maximum number of NCSG as zero. At S708, the method includes releasing at least one of the not allowed preconfigured measurement gap created on the FR2 of the wireless network (1000), the multiple measurement gaps created on the FR2 of the wireless network (1000), and the multiple NCSG created on the FR2 of the wireless network (1000). At S710, the method includes creating the at least one UE (300) associated with the first node with the single measurement gap on the FR2 of the wireless network (1000).

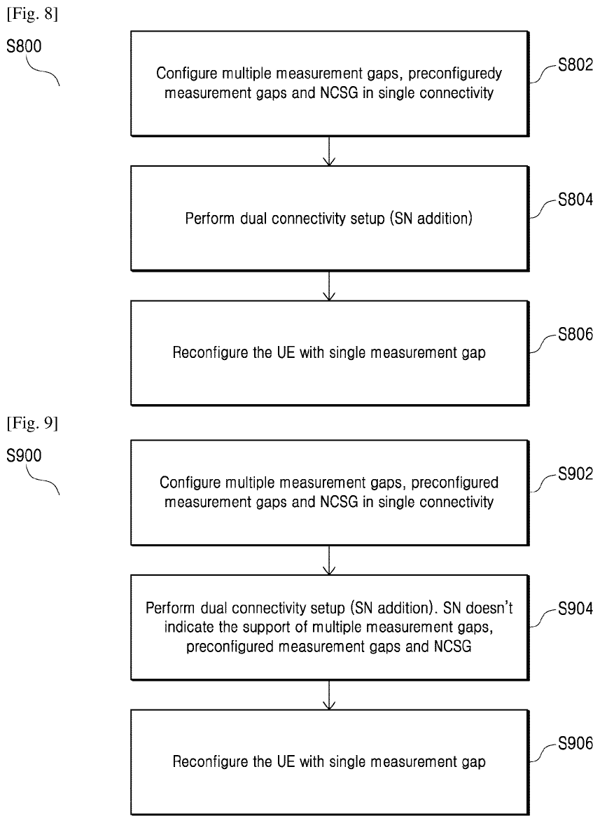

FIG. 8 is a flow chart (S800) illustrating the MGE reconfiguration at the DC setup, according to the embodiments as disclosed herein. At S802, the method includes configuring the multiple measurement gaps, the preconfigured measurement gaps and the NCSG in single connectivity. At S804, the method includes performing the dual connectivity setup (SN addition). At S806, the method includes reconfiguring the UE (300) with the single measurement gap.

FIG. 9 is a flow chart (S900) illustrating the MGE reconfiguration at the DC setup, according to the embodiments as disclosed herein. At S902, the method includes configuring the multiple measurement gaps, the preconfigured measurement gaps and the NCSG in single connectivity. At S904, the method includes performing the dual connectivity setup (SN addition). The SN doesn't indicate the support of multiple measurement gaps, preconfigured measurement gaps and NCSG. At S906, the method includes reconfigure the UE (300) with the single measurement gap.

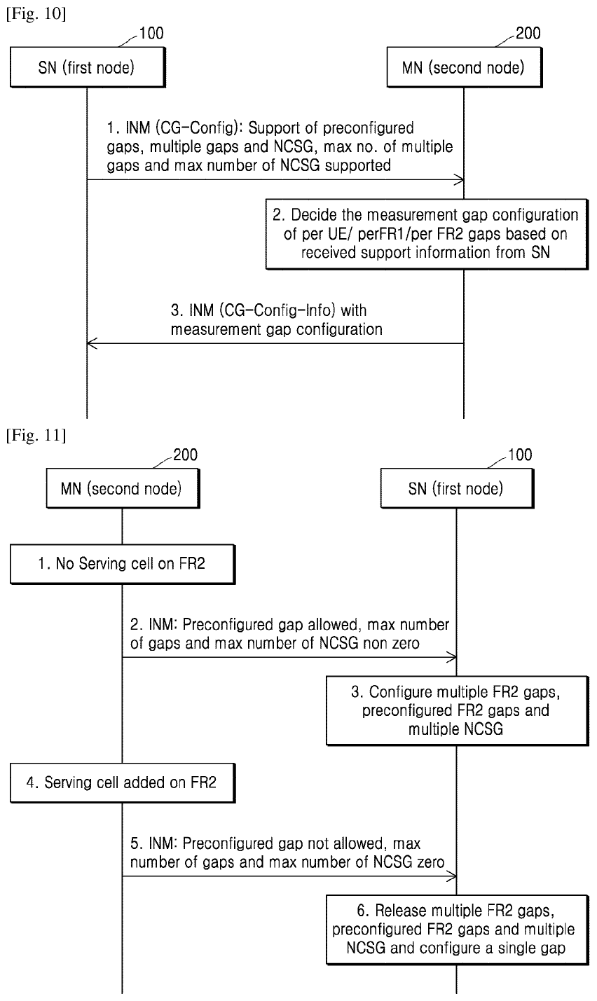

FIG. 10 illustrates an example scenario of updating the MN (200) on the SN capability for NR measurement enhancement, according to the embodiments as disclosed herein. At 1, the SN (100) sends the INM (CG-Config) supporting of the preconfigured gaps, the multiple gaps, the NCSG, maximum number of multiple gaps and maximum number of NCSG supported to the MN (200). At 2, the MN (200) decides the measurement gap configuration of per UE/perFR1/FR2 gaps based on the received support information from the SN (100). At 3, the MN (200) sends the INM (CG-Config-Info) with measurement gap configuration to the SN (100).

FIG. 11 illustrates an example inter node capability coordination for per FR2 gaps in EN-DC/NG-EN-DC where the MN (200) doesn't support NR measurement enhancement algorithm block, according to the embodiments as disclosed herein. At 1, the MN (200) detects that no serving cell is on the FR2. At 2, the MN (200) sends the INM indicating the preconfigured gap allowed, maximum number of gaps and maximum number of NCSG non zero to the SN (100). At 3, the SN (100) configures the multiple FR2 gaps, preconfigured FR2 gaps and multiple NCSG. At 4, the MN (100) detects that the serving cell is added on the FR2. At 5, the MN (200) sends the INM indicating the preconfigured gap not allowed, the maximum number of gaps and the maximum number of NCSG zero to the SN (100). At 6, the SN (200) releases the multiple FR2 gaps, preconfigured FR2 gaps and multiple NCSG and configures the single gap.

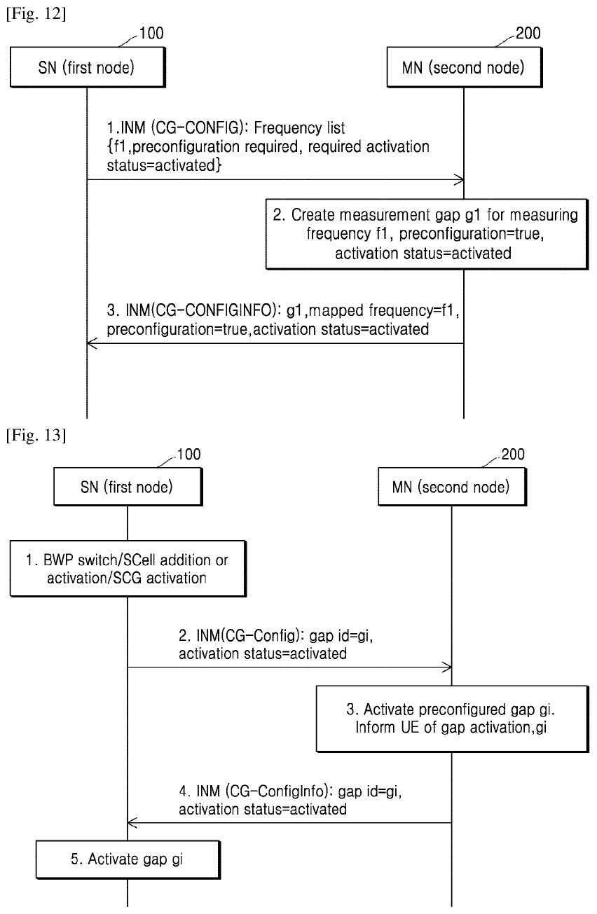

FIG. 12 illustrates an example scenario of MN-SN coordination during configuration of multiple gaps and preconfigured gaps, according to the embodiments as disclosed herein. At 1, the SN (100) sends the INM (including the CG-CONFIG): Frequency list {f1, reconfiguration required, required activation status=activated} to the MN (200). At 2, the MN (200) creates the measurement gap g1 for measuring frequency f1, preconfiguration=true, and activation status=activated. At 3, the MN (100) sends the INM (CG-CONFIGINFO): g1,mapped frequency=f1, pre-configuration=true, activation status=activated) to the SN (100).

FIG. 13 illustrates an example scenario of gap activation due to BWP switch/SCell addition or activation/SCG activation at the SN (100), according to the embodiments as disclosed herein. At 1, the SN (100) detects the BWP switch/SCell addition or activation/SCG activation. At 2, the SN (100) sends the INM (CG-Config): gap id=g1, activation status=activated to the MN (200). At 3, the MN (200) activates the preconfigured gap g1 and informs UE (300) of gap activation, g1. At 4, the MN (200) sends the INM (CG-ConfigInfo): gap id=g1, activation status=activated to the SN (100). At 5, the SN (100) activates the gap g1.

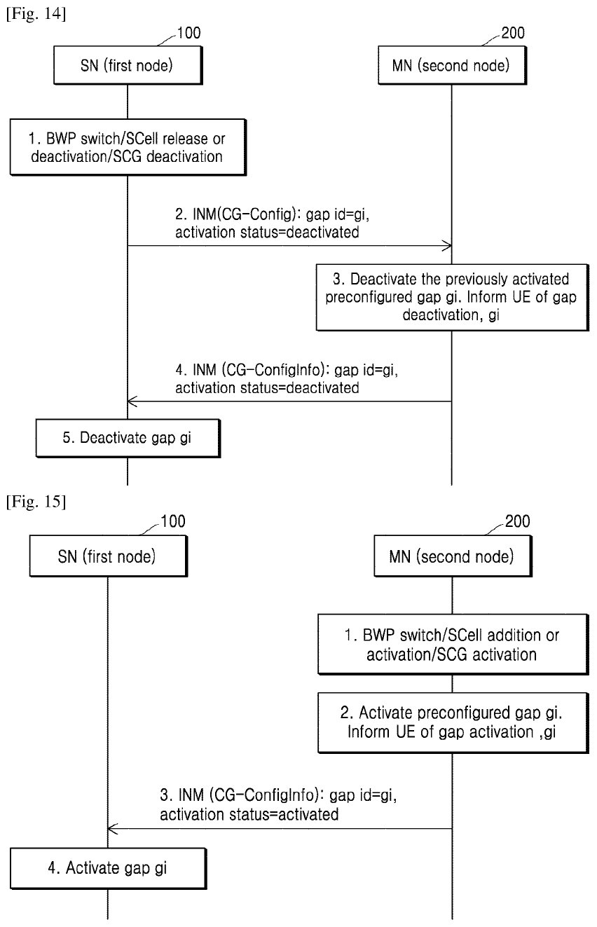

FIG. 14 illustrates an example scenario of gap deactivation due to BWP switch/SCell release or deactivation/SCG deactivation at the SN (100), according to the embodiments as disclosed herein. At 1, the SN (100) detects the BWP switch/SCell release or deactivation/SCG deactivation. At 2, the SN (100) sends the INM (CG-Config): gap id=g1, activation status=deactivated to the MN (200). At 3, the MN (200) deactivates the previously activated preconfigured gap g1 and informs UE (300) of gap deactivation, g1. At 4, the MN (200) sends the INM (CG-ConfigInfo): gap id=g1, activation status=deactivated to the SN (100). At 5, the SN (100) deactivates the gap g1.

FIG. 15 illustrates an example scenario of gap activation due to BWP switch/SCell addition or activation/SCG activation at the MN (200), according to the embodiments as disclosed herein. At 1, the MN (200) detects the BWP switch/SCell addition or activation/SCG activation. At 2, the MN (200) activates the preconfigured gap g1 and informs the UE (300) of gap activation, g1. At 3, the MN (200) sends the INM (including the CG-ConfigInfo): gap id=g1, activation status=activated to the SN (100). At 4, the SN (100) activates the gap g1.

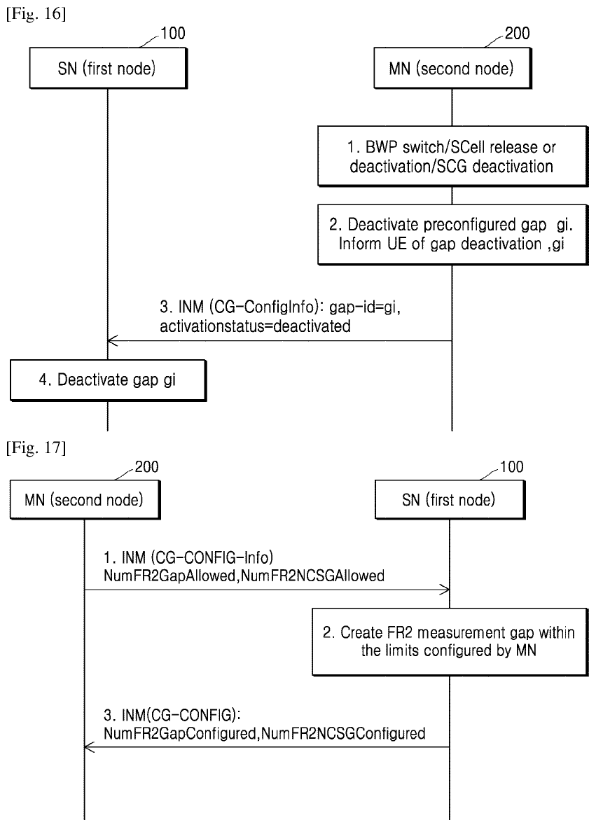

FIG. 16 illustrates an example scenario of gap deactivation due to BWP switch/SCell release or deactivation/SCG deactivation at the MN (200), according to the embodiments as disclosed herein. At 1, the MN (200) detects the BWP switch/SCell release or deactivation/SCG deactivation. At 2, the MN (200) deactivates the preconfigured gap g1 and informs the UE (300) of gap deactivation, g1. At 3, the MN (200) sends the INM (including the CG-ConfigInfo): gap id=g1, activation status=deactivated to the SN (100). At 4, the SN (100) deactivates the gap g1.

FIG. 17 illustrates a scenario of MN-SN coordination on max number of gaps to be configured, according to the embodiments as disclosed herein. At 1, MN (200) sends the INM (including the CG-CONFIG-Info) NumFR2GapAllowed, NumFR2NCSGAllowed to the SN (200). At 2, the SN (100) creates the FR2 measurement gap within the limits configured by the MN (200). At 3, the SN (100) sends the INM (CG-CONFIG): NumFR2GapConfigured, NumFR2NCSGConfigured to the MN (200)

The various actions, acts, blocks, steps, or the like in the flow charts (S400-S700) may be performed in the order presented, in a different order or simultaneously. Further, in some embodiments, some of the actions, acts, blocks, steps, or the like may be omitted, added, modified, skipped, or the like without departing from the scope of the embodiments in the disclosure.

Further, the method of the disclosure may be performed in a combination of some or all of content included in each embodiment of the disclosure within a range that does not depart from the essence of the disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first base station in a wireless communication system, the method comprising:
receiving, from a second base station, capability information indicating whether the second base station supports multiple measurement gaps, a preconfigured gap or network controlled small gap (NCSG); and
transmitting, to the second base station, measurement gap configuration in case that the second base station supports the multiple measurement gaps, the preconfigured gap or the NCSG.

17. The method of claim 16, further comprising:
in case that the second base station does not support the multiple measurement gaps, the preconfigured gap or the NCSG, transmitting, to a user equipment (UE), reconfiguration information including information indicating single measurement gap.

18. The method of claim 16, wherein the capability information is included in an inter-node RRC message or Xn message,
wherein the capability information include maximum number of measurement gaps, maximum number of NCSG, maximum number of measurement gaps and NCSG together, maximum number of preconfigured gaps, maximum number of per UE or per FR gaps, and information indicating whether the second base station supports measurement gap separately for per UE, per FR1, or per FR2.

19. The method of claim 18, further comprising:
transmitting, to the second base station, information indicating a number of measurement gaps that are allocated.

20. The method of claim 16, further comprising:
transmitting, to the second base station, information indicating whether the second base station is allowed to configure the preconfigured gap, the NCSG, and the multiple measurement gaps, based on the capability information.

21. The method of claim 16, further comprising:
receiving, from the second base station, information indicating at least one frequency to be measured, information indicating whether pre-configuration of measurement gap is required for the at least one frequency, and initial activation status required of the preconfigured gap for the at least one frequency.

22. The method of claim 16, further comprising:
receiving, from the second base station, information indicating activation status of the preconfigured gap.

23. A first base station in a wireless communication system, the first base station comprising:
at least one transceiver; and
at least one processor coupled to the at least one transceiver and configured to:
receive, from a second base station, capability information indicating whether the second base station supports multiple measurement gaps, a preconfigured gap or network controlled small gap (NCSG); and
transmit, to the second base station, measurement gap configuration in case that the second base station supports the multiple measurement gaps, the preconfigured gap or the NCSG.

24. The first base station of claim 23, wherein the at least one processor is configured to:
in case that the second base station does not support the multiple measurement gaps, the preconfigured gap or the NCSG, transmit, to a user equipment (UE), reconfiguration information including information indicating single measurement gap.

25. The first base station of claim 23, wherein the capability information is included in an inter-node RRC message or Xn message,
wherein the capability information includes maximum number of measurement gaps, maximum number of NCSG, maximum number of measurement gaps and NCSG together, maximum number of preconfigured gaps, maximum number of per UE or per FR gaps, and information indicating whether the second base station supports measurement gap separately for per UE, per FR1, or per FR2.

26. The first base station of claim 25, wherein the at least one processor is configured to:
transmit, to the second base station, information indicating a number of measurement gaps that are allocated.

27. The first base station of claim 23, wherein the at least one processor is configured to:
transmit, to the second base station, information indicating whether the second base station is allowed to configure the preconfigured gap, the NCSG, and the multiple measurement gaps, based on the capability information.

28. The first base station of claim 23, wherein the at least one processor is configured to:
receive, from the second base station, information indicating at least one frequency to be measured, information indicating whether pre-configuration of a measurement gap is required for the at least one frequency, and initial activation status required of the preconfigured gap for the at least one frequency.

29. The first base station of claim 23, wherein the at least one processor is configured to:
receive, from the second base station, information indicating activation status of the preconfigured gap.

30. A method performed by a second base station in a wireless communication system, the method comprising:
transmitting, to a first base station, capability information indicating whether the second base station supports multiple measurement gaps, a preconfigured gap or network controlled small gap (NCSG); and
receiving, from the first base station, measurement gap configuration in case that the second base station supports the multiple measurement gaps, the preconfigured gap or the NCSG.
